(19) United States
(12) Patent Application Publication
(10) Pub. No.: US 2012/0070278 A1
(43) Pub. Date: Mar. 22, 2012

(54) GAS TURBINE ENGINE BEARING ARRANGEMENT

(75) Inventor: Alan R. MAGUIRE, Derby (GB)

(73) Assignee: ROLLS-ROYCE PLC, London (GB)

(21) Appl. No.: 13/215,792

(22) Filed: Aug. 23, 2011

(30) Foreign Application Priority Data
Sep. 16, 2010 (GB) 1015437.5

(51) Int. Cl. F01D 25/16; F16C 19/00; F04D 21/00

(52) U.S. Cl. 415/229; 415/181; 384/445

(57) ABSTRACT

A gas turbine engine comprising first and second rotor shafts and an intershaft rolling element bearing arranged between the shafts. The first rotor shaft has a stator stage and a rotor stage; the second rotor shaft has only a rotor stage and is arranged to contra-rotate relative to the first shaft. The intershaft bearing is arranged between the first and second shafts such that the relative speeds of the shafts minimise a cage speed of the intershaft bearing.

The present invention relates to a gas turbine engine having contra-rotating shafts and an intershaft bearing arranged between those shafts.

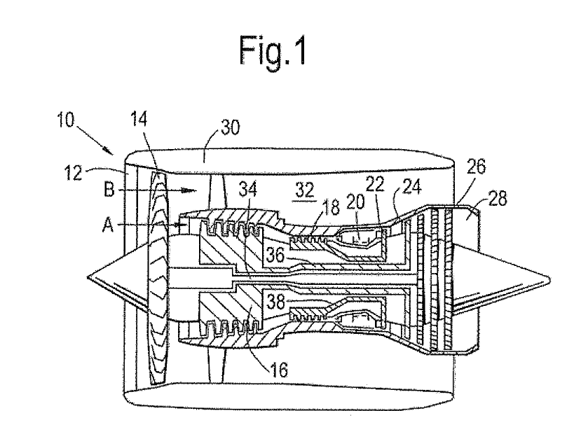

A conventional three-shaft gas turbine engine 10 is shown in FIG. 1 and comprises an air intake 12 and a propulsive fan 14 that generates two airflows A and B. A nacelle 30 surrounds the gas turbine engine 10 and defines, in axial flow B, a bypass duct 32. The gas turbine engine 10 comprises, in axial flow A, an intermediate pressure compressor 16, a high pressure compressor 18, a combustor 20, a high pressure turbine 22, an intermediate pressure turbine 24, a low pressure turbine 26 and an exhaust nozzle 28. The fan 14 is coupled to the low pressure turbine 26 by a low pressure shaft 34; the intermediate pressure compressor 16 is coupled to the intermediate pressure turbine 24 by an intermediate pressure shaft 36; and the high pressure compressor 18 is coupled to the high pressure turbine 22 by a high pressure shaft 38. The three shafts 34, 36, 38 are coaxial and co-rotate.

It is known to provide an intershaft rolling element bearing between the co-rotating low pressure and intermediate pressure shafts 34, 36 or between the co-rotating intermediate pressure and high pressure shafts 36, 38. However, the relative speeds of rotation to which the contact surfaces of the rolling elements are subjected results in a relatively high cage speed, N_{cage}, typically of the order of 15,000 rpm. The cage speed is defined as the tangential velocity of the rolling elements about the engine axis. This in turn results in a high stress induced by centrifugal forces acting on the bearing elements, Stress_{CF}, typically of the order of 1500-2000 MPA. This has a detrimental effect on the life of the bearing since life is inversely proportional to the ninth power of Stress_{CF}, Life∝Stress_{CF}⁻⁹.

The work split between the turbines 22, 24, 26 of a conventional three-shaft gas turbine engine 10 is such that the intermediate pressure turbine 24 is located at a relatively large radius from the engine axis. However, this causes larger centrifugal stresses on all the components, and causes sealing problems at the annulus rim. Additionally, this work split requires a large number of rotor stages for the intermediate pressure compressor 16 relative to the high pressure compressor 18 which adds to the weight of the engine. Furthermore, the temperature drop across the high pressure turbine 22 is insufficient to cool the air so that rotor blade and stator vane cooling is required in the intermediate pressure turbine 24 components which also adds to the weight, cost and complexity of the gas turbine engine 10.

It would be beneficial to provide a gas turbine engine 10 having fewer intermediate compressor 16 stages, requiring less cooling of the turbine components and that reduces the centrifugal stresses induced in components.

Accordingly the present invention provides a gas turbine engine comprising a first rotor shaft having a stator stage comprising an annular array of stator blades and a rotor stage comprising an annular array of rotor blades; a second rotor shaft having only a rotor stage comprising an annular array of rotor blades, the second shaft arranged to contra-rotate relative to the first shaft; and an intershaft rolling element location bearing arranged between the first and second shafts, wherein the relative speeds of the shafts minimises a cage speed of the intershaft bearing. The intershaft bearing locates radially and axially.

Advantageously, the gas turbine engine is axially shorter and lighter than a conventional gas turbine engine. There is less wear on the components of the bearing, and less component cooling required.

The first rotor shaft may be a high pressure shaft. The second rotor shaft may be an intermediate pressure shaft or a low pressure shaft. Each rotor stage may comprise a turbine stage.

The rotor stage of the first rotor shaft may expel supersonic air and the rotor stage of the second rotor shaft may expel subsonic air.

The cage speed of the intershaft bearing may be less than 2,000 rpm.

Each rotor stage may comprise a compressor or fan stage.

The present invention also provides an intershaft rolling element bearing having a minimal cage speed, for a gas turbine engine as described above.

The present invention will be more fully described by way of example with reference to the accompanying drawings, in which:

FIG. 1 is a sectional side view of a gas turbine engine according to the prior art.

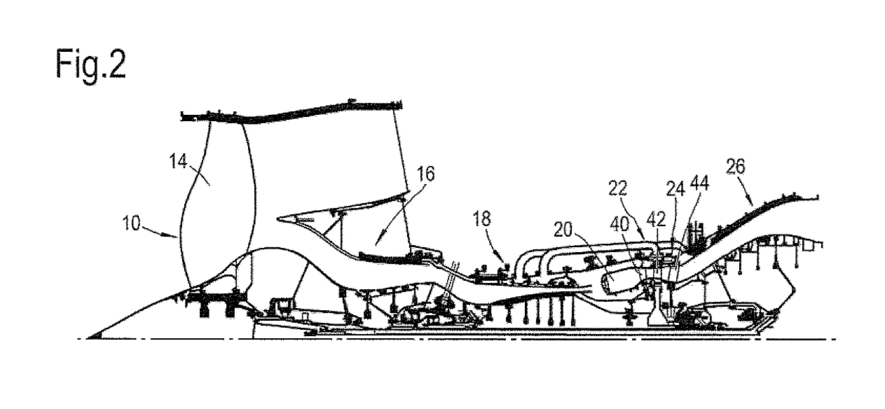

FIG. 2 is a sectional side view of the top half of a gas turbine engine according to the present invention.

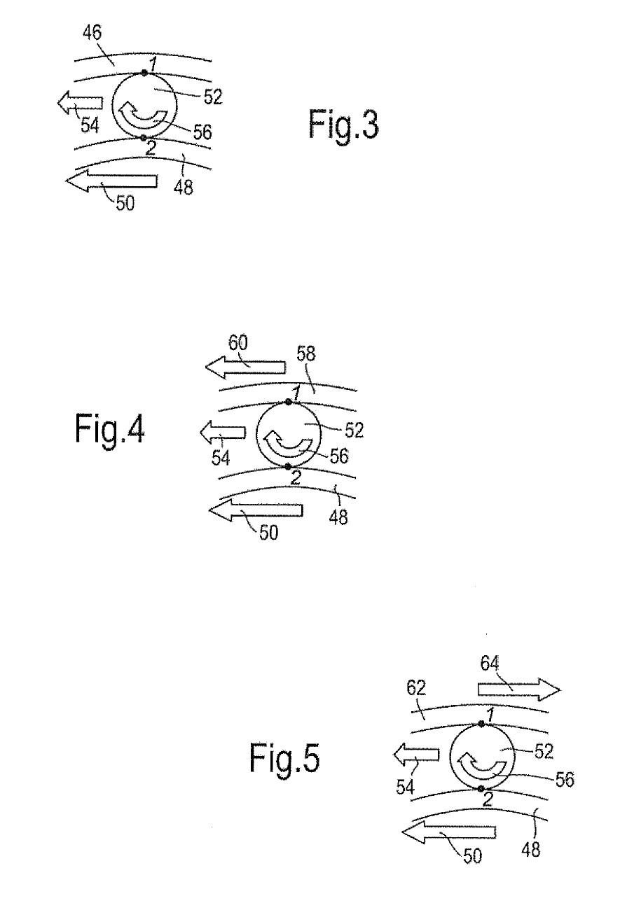

FIG. 3 is a schematic illustration of the relative speeds experienced by an intershaft bearing according to a first prior art arrangement.

FIG. 4 is a schematic illustration of the relative speeds experienced by an intershaft bearing according to a second prior art arrangement.

FIG. 5 is a schematic illustration of the relative speeds experienced by an intershaft bearing according to the present invention.

An exemplary embodiment of the gas turbine engine 10 according to the present invention is shown in FIG. 2. The gas turbine engine 10 comprises the same components as in FIG. 1. However, the high pressure shaft 38 and the intermediate pressure shaft 36 are arranged to contra-rotate. In a preferred embodiment the low pressure shaft 34 and the high pressure shaft 38 co-rotate, the intermediate pressure shaft 36 contra-rotating with respect to each of the other shafts.

The high pressure turbine 22 comprises an annular array of stator vanes 40 and an annular array of rotor blades 42, as in the prior art. The stator vanes 40 receive hot combustion gases from the combustor 20 and direct the flow downstream towards the rotor blades 42. The rotor blades 42 act in conventional manner to decelerate and expand the flow. Nonetheless, the swirling flow exiting the high pressure turbine 22 is supersonic. The high pressure turbine 22 performs more work than a conventional high pressure turbine 22 having subsonic exit flow. Therefore the temperature drop across the high pressure turbine 22 is increased. This means that blade cooling is not required for the intermediate pressure turbine 24. Beneficially this reduces the amount of air extracted from the compressors 16, 18 and therefore improves the engine efficiency. It also reduces the engine weight, as there is no requirement for ducting and the like to deliver cooling air, and may simplify the manufacture of the intermediate pressure turbine 24 components as cooling passages and film cooling holes are not required.

The intermediate pressure turbine 24 is positioned so that its annular array of rotor blades 44 is close to the rotor blades 42 of the high pressure turbine 22 in the downstream direction. Unlike the conventional arrangement in FIG. 1, there is no annular array of stator vanes for the intermediate pressure turbine 24 because the air exiting the high pressure turbine rotor blades 42 is at a suitable incidence angle for the contra-rotating intermediate pressure turbine rotor blades 44. The number of rotor blades 42, 44 in each stage may be reduced depending on the specific engine application. Thus the weight of the engine is advantageously reduced by at least the weight of a stage of stator vanes.

Since the rotor blades 44 of the intermediate pressure turbine 24 closely follow the rotor blades 42 of the high pressure turbine 22, they are located at a smaller engine radius than the co-rotating prior art. This reduces the centrifugal stress exerted on the rotor blades 44 and associated components and hence the components are less susceptible to creep fatigue and similar degradation.

An additional benefit of increasing the work done by the high pressure turbine 22 relative to the intermediate pressure turbine 24 is that the number of rotor and stator stages required for their respective compressors is changed. The exact number of compressor stages in each compressor 16, 18 is dependent on the specific engine application but an exemplary application reduces the number of compressor stages by three, reduces the number of intermediate pressure turbine blades 44 by fifty to one hundred and removes all the intermediate pressure turbine vanes 40. This represents a substantial weight saving over the prior art.

FIG. 3 illustrates the speeds experienced by a bearing having a static outer race 46 which is coupled, for example, to a static part of the engine casing. The inner race 48 rotates at a tangential velocity Uᵢₙₙₑᵣ indicated by arrow 50. The inner race 48 may form part of or be coupled to a shaft 34, 36, 38 of the gas turbine engine 10. The bearing comprises an array of rolling elements 52, one of which is illustrated, that may be ball bearings or have another form as well known in the art. The rolling elements 52 are held in relative position by a cage (not illustrated) and process circumferentially between the outer race 46 and inner race 48 at a speed U_{cage} indicated by arrow 54. Each rolling elements 52 rotates about its own centre at a speed Uₑₗₑₘₑₙₜ indicated by arrow 56.

Point 1 is where the rolling element 52 impacts on the static outer race 46. Point 2 is where the rolling element 52 impacts on the rotating inner race 48. Points 1 and 2 are illustrated at top dead centre and bottom dead centre respectively. However, it will be apparent to the skilled reader that the contact point 1 will actually be where the resultant of the centrifugal and axial location forces meets the outer race 46 at a contact angle from the radial direction. Similarly contact point 2 will be diametrically opposite to this, where the projection of the resultant force meets the inner race 48. Two simultaneous equations can be written thus and solved to determine Uₑₗₑₘₑₙₜ and U_{cage} since Uᵢₙₙₑᵣ is known from the engine 10:

$$\begin{matrix}0 = {U}_{cage} - {U}_{element} \\ {U}_{inner} = {U}_{cage} + {U}_{element}\end{matrix} ⇒ {U}_{cage} = {U}_{element} = \frac{1}{2} {U}_{inner}$$

Using cage and ball radii from a conventional gas turbine engine 10, the rotational speeds can be calculated and typically are of the order of N_{cage}=8,000 rpm and Nₑₗₑₘₑₙₜ=60,000 rpm. The centrifugal stress is proportional to mₑₗₑₘₑₙₜ×U_{cage}²×r_{cage}, where mₑₗₑₘₑₙₜ is the mass of the ball and r_{cage} is the radius of the cage. Therefore Stress_{CF} is of the order of 600 MPa. This has a detrimental effect on the life of the rolling elements 52 in the bearing because life is inversely proportional to the ninth power of centrifugal stress, Life∝Stress_{CF}⁻⁹.

FIG. 4 is similar to FIG. 3 but illustrates an intershaft bearing that has a rotating outer race 58 that rotates in the same direction, but at a different speed, to the inner race 48 instead of a static outer race 46. The outer race 58 rotates at a velocity Uₒᵤₜₑᵣ in the direction indicated by arrow 60, tangential to its circumference. Thus the two simultaneous equations can be written thus and solved as before:

$$\begin{matrix}{U}_{outer} = {U}_{cage} - {U}_{element} \\ {U}_{inner} = {U}_{cage} + {U}_{element}\end{matrix} ⇒ {U}_{cage} = \frac{{U}_{inner} + {U}_{outer}}{2}$$

$$and$$

$${U}_{element} = \frac{{U}_{inner} + {U}_{outer}}{2}$$

Using the same cage and ball radii as for FIG. 3, the rotational speeds are of the order of N_{cage}=15,000 rpm and Nₑₗₑₘₑₙₜ=10,000 rpm. The centrifugal stress in this case is of the order of 2000 MPa, more than three times greater than for the bearing of FIG. 3.

FIG. 5 illustrates the relative speeds acting on the rolling element 52 of the intershaft bearing according to the present invention. The outer race 62 contra-rotates with respect to the inner race 48, at a velocity Uₒᵤₜₑᵣ in a direction indicated by arrow 64. This changes the sign of one of the terms of the first of the simultaneous equations and thus the resulting velocities:

$$\begin{matrix}{U}_{outer} = {U}_{element} - {U}_{cage} \\ {U}_{inner} = {U}_{cage} + {U}_{element}\end{matrix} {U}_{cage} = \frac{{U}_{inner} + {U}_{outer}}{2}$$

$$and ⇒ {U}_{element} = \frac{{U}_{inner} + {U}_{outer}}{2}$$

Using the same cage and ball radii as for FIGS. 3 and 4, the rotational speeds for the present invention are of the order of N_{cage}=1,000 rpm and Nₑₗₑₘₑₙₜ=120,000 rpm, thereby minimising the cage speed within the design constraints of engine radius and rolling element 52 radius. Thus the centrifugal stress is substantially reduced, to be in the order of 30 MPa, twenty times smaller than for the bearing of FIG. 3 and more than sixty times smaller than for the intershaft bearing of FIG. 4. Hence substantially less damage is inflicted on the rolling elements 52 in the contra-rotating intershaft bearing than in the rotating-static bearing or co-rotating intershaft bearing. Advantageously, this increases the life of the rolling elements 52 and the outer race 62.

An additional benefit of the intershaft bearing of the present invention is that the faster the rotational speed of the rolling elements 52, the better the rate of cooling because more cooling fluid is entrained in the wake of each rolling element 52. Thus the rolling elements 52 in FIG. 5 entrain more cooling fluid than the rolling elements 52 in FIG. 3 and significantly more than the rolling elements 52 in FIG. 4.

Thus the gas turbine engine 10 of the present invention, that comprises contra-rotating rotor shafts 36, 38 and an intershaft bearing, benefits from the advantageous effects of reduced weight and complexity of the turbines 22, 24, improved temperature drop across the high pressure turbine 22 resulting in a reduced cooling requirement, and longer life rolling elements 52 in the intershaft bearing, Advantageously, the cage speed U_{cage} is reduced as a consequence of contra-rotating the outer race 62 and inner race 48. If the design flexibility is available, the cage speed may be minimised by altering the relative race velocities 50, 64.

The gas turbine engine 10 also has a reduced axial length compared to conventional gas turbine engines 10 since the intermediate pressure turbine 24 does not include a stator stage and is closer to the high pressure turbine 22. Beneficially this means that nacelle drag is reduced, the total engine weight is reduced since less casing is required inter alia, and integration with the airframe is simplified. This results in reduced fuel burn which in turn reduces operating costs for the aircraft. Where the gas turbine engine 10 is used in a marine or industrial application, the reduced axial length enables easier fitting and the reduced weight enables more flexibility in positioning, for example in a ship.

Although the present invention has been described with respect to a three-shaft gas turbine engine 10 with the high pressure and intermediate pressure shafts 36, 38 arranged to contra-rotate, it will be apparent to the skilled reader that many of the benefits and advantages can also be obtained by arranging the low pressure and intermediate pressure shafts 34, 36 to contra-rotate. The intermediate pressure shaft 36 may contra-rotate with respect to each of the high pressure and low pressure shafts 34, 38, in which case at least one intershaft bearing is provided between each pair of shafts. The present invention can be applied with equal felicity to a two-shaft gas turbine engine 10, with the high and low pressure shafts 34, 38 arranged to contra-rotate.

Although the contra-rotating intershaft bearing has been described between the shafts and related to the turbines 22, 24, 26, a contra-rotating intershaft bearing can be provided between the shafts and related to the fan 14 and compressors 16, 18. This may be in addition to the intershaft bearing related to the turbines 22, 24, 26.

For example, a contra-rotating intershaft location bearing according to the present invention may be provided for a two-shaft geared fan gas turbine engine. The intershaft bearing in this case is located between the low pressure turbine and the fan where the fan is geared to contra-rotate at a different speed to the low pressure turbine which rotates at relatively high speed. In this case the intershaft bearing reacts the axial fan load as well as the centrifugal load leaving the gearbox substantially unloaded in the axial direction. Advantageously this enables the fan support to straddle the gearbox arrangement thereby improving its stability.

1. A gas turbine engine comprising:
a first rotor shaft having a stator stage comprising an annular array of stator blades and a rotor stage comprising an annular array of rotor blades;
a second rotor shaft having only a rotor stage comprising an annular array of rotor blades, the second shaft arranged to contra-rotate relative to the first shaft; and
an intershaft rolling element location bearing arranged between the first and second shafts, wherein the relative speeds of the shafts minimises a cage speed of the intershaft bearing.

2. A gas turbine engine as claimed in claim 1 wherein the first rotor shaft is a high pressure shaft.

3. A gas turbine engine as claimed in claim 1 wherein the second rotor shaft is an intermediate pressure shaft.

4. A gas turbine engine as claimed in claim 1 wherein the second rotor shaft is a low pressure shaft.

5. A gas turbine engine as claimed in claim 1 wherein each rotor stage comprises a turbine stage.

6. A gas turbine engine as claimed in claim 1 wherein the rotor stage of the first rotor shaft expels supersonic air and the rotor stage of the second rotor shaft expels subsonic air.

7. A gas turbine engine as claimed in claim 1 wherein the cage speed of the intershaft bearing is less than 2000 rpm.

8. A gas turbine engine as claimed in claim 1 wherein each rotor stage comprises a compressor or fan stage.

9. An intershaft rolling element bearing having a minimal cage speed, for a gas turbine engine as claimed in claim 1.
